(19) United States
(12) Patent Application Publication
(10) Pub. No.: US 2025/0249774 A1
(43) Pub. Date: Aug. 7, 2025

(54) SYSTEMS AND METHODS FOR RECOMMENDING ELECTRIC VEHICLE CHARGING STATION

(71) Applicant: Ford Global Technologies, LLC, Dearborn, MI (US)

(72) Inventors: John Robert Van Wiemeersch, Novi, MI (US); Brendan Diamond, Dearborn, MI (US); Annette Lynn Huebner, Highland, MI (US); Keith Weston, Dearborn, MI (US); Stuart C. Salter, White Lake, MI (US); Aaron L. Mills, Ann Arbor, MI (US)

(73) Assignee: Ford Global Technologies, LLC, Dearborn, MI (US)

(21) Appl. No.: 18/434,398

(22) Filed: Feb. 6, 2024

(51) Int. Cl. B60L 53/62; B60L 53/65

(52) U.S. Cl. CPC B60L 53/62; B60L 53/65

(57) ABSTRACT

A recommendation system including a transceiver and a processor is disclosed. The transceiver may be configured to receive charging station information. The charging station information may include information associated with real-time waiting times and presence of fast chargers at a plurality of charging stations located in a geographical area. The processor may be configured to obtain a trigger signal, and estimate a vehicle charging time associated with each charging station based on the charging station information responsive to obtaining the trigger signal. The processor may further determine a recommended charging station, from the plurality of charging stations, based on the vehicle charging time. The processor may additionally output recommended charging station information responsive to determining the recommended charging station.

### FIELD

The present disclosure relates to systems and methods for recommending an electric vehicle (EV) charging station to charge an EV.

### BACKGROUND

Electric Vehicles (EVs) require regular charging at EV charging stations to ensure optimal vehicle operation. There are times when users may feel uncomfortable visiting a particular EV charging station, because the charging station may be located in a secluded area or may not have proper lighting. Visiting such charging stations and stopping to charge the vehicles at such stations may cause inconvenience to the users. Further, adverse events are known to occur at secluded places, and hence many users prefer not to charge their vehicles at such charging stations.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an electric vehicle charging recommendation system in accordance with the present disclosure.

FIG. 3 depicts an example snapshot of a vehicle with an illuminated perimeter light located at a charging station in accordance with the present disclosure.

FIG. 4 depicts an example snapshot of a vehicle displaying a notification via a vehicle Human-Machine Interface (HMI) in accordance with the present disclosure.

FIG. 5 depicts an example snapshot of two vehicles with illuminated perimeter lights located at a charging station in accordance with the present disclosure.

FIG. 6 depicts an example snapshot of a user and a vehicle monitoring another vehicle located at a charging station in accordance with the present disclosure.

FIG. 7 depicts a flow diagram of an example electric vehicle charging recommendation method in accordance with the present disclosure.

### DETAILED DESCRIPTION

### Overview

The present disclosure describes a system and method to identify and recommend an optimal charging station to a vehicle user to enable charging of a vehicle. The system may further perform one or more predefined actions to enhance the user's experience of charging the vehicle at the recommended charging station, especially if the charging station is located in a secluded area, have improper lighting, non-working cameras, absence of authorities/guards, and/or the like.

In a first exemplary aspect, the system may identify and recommend a charging station (e.g., a first charging station), from a plurality of charging stations in a geographical area, to the vehicle user such that the first charging station may be associated with the shortest or lowest vehicle charging time. For example, the system may recommend the first charging station such that the first charging station may have the shortest waiting time and/or have presence of fast chargers.

In a second exemplary aspect, the system may identify and recommend the first charging station such that a vehicle travel time from a current vehicle geolocation to the first charging station may be lowest amongst the vehicle travel times to the other charging stations in the geographical area.

In a third exemplary aspect, the system may identify and recommend the first charging station such that the first charging station may have an acceptability rating greater than a user desired acceptability rating. In some aspects, an acceptability rating for a charging station may be associated with a presence of cameras, a presence of authorities, a presence of an escort to and from the charging station, historical adverse event rate at the charging station, a presence of one or more places of interest (e.g., restaurants, cafés, etc.) in proximity to the charging station, a presence of a waiting facility with an attendant at the charging station, and/or the like.

In a fourth exemplary aspect, the system may identify and recommend the first charging station such that the first charging station may have presence of wireless chargers (if the vehicle has wireless charging capability).

In further aspects, the system may be configured to recommend a second charging station, from the plurality of charging stations, to the vehicle user when the vehicle reaches the first charging station and the vehicle user does not like the first charging station (e.g., when the first charging station may be in a suboptimal condition). The second charging station may be, for example, closest to the first charging station, or may be the closest charging station with an acceptability rating greater than the user desired acceptability rating. The system may be additionally configured to determine and recommend a minimum vehicle charge that the vehicle user may transfer to the vehicle at the first charging station, which may enable the vehicle to conveniently travel from the first charging station to the second charging station.

The system may be further configured to enable the vehicle to adjust/adapt the vehicle's charging strategy (e.g., charge for an optimal time duration), based on real-time charging station information associated with the first charging station, when the vehicle reaches the first charging station or may be getting charged at the first charging station. The real-time charging station information may include, for example, information associated with a count of users or vehicles located at the first charging station, a presence of authorities at the first charging station, and/or the like.

The system may additionally cause the vehicle to activate its perimeter lights, activate exterior vehicle cameras and start recording, cause lights associated with one or more additional vehicles and/or infrastructure lights in proximity to the vehicle to illuminate, and/or the like, to further enhance user's charging experience at the first charging station. The system may further enable/facilitate a group of vehicles to collectively charge at the first charging station, and/or request one or more vehicles or users to monitor the vehicle at the first charging station, when the vehicle may be getting charged at the first charging station.

The present disclosure discloses a system and method to recommend an optimal charging station to a vehicle user, and/or enhance user's vehicle charging experience at the charging station, especially if the charging station is located at a secluded area or be in a suboptimal condition. The system enables the vehicle user to quickly charge the vehicle at the recommended charging station, thereby ensuring that the vehicle user does not have to spend a considerable time duration at the charging station. The system further facilitates illumination of the area where the vehicle may be located at the charging station, thereby enhancing user's comfort when the vehicle may be getting charged.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

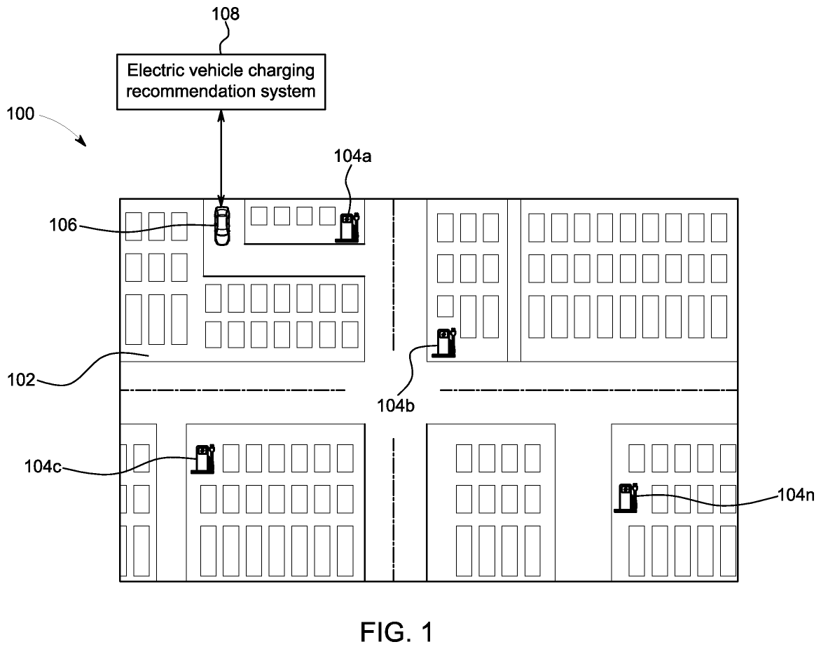

FIG. 1 depicts an example environment 100 in which techniques and structures for providing the systems and methods disclosed herein may be implemented. The environment 100 may include a geographical area 102 including a plurality of Electric Vehicle (EV) charging stations 104a, 104b, 104c, 104n (collectively referred to as charging stations 104). The environment 100 may further include a vehicle 106 that may get charged at the charging stations 104.

The vehicle 106 may take the form of any passenger or commercial vehicle such as, for example, a car, a work vehicle, a crossover vehicle, a truck, a van, a minivan, a taxi, a bus, etc. Further, the vehicle 106 may be a manually driven vehicle, and/or may be configured to operate in a fully autonomous (e.g., driverless) mode or a partially autonomous mode, and may include one or more electrically-actuated motor(s) or a hybrid system.

The vehicle 106 may be communicatively coupled with an electric vehicle charging recommendation system 108 (or system 108) that may be configured to identify and recommend one or more charging stations, from the charging stations 104, at which a vehicle user (not shown) associated with the vehicle 106 may charge the vehicle 106. In some aspects, the system 108 may be part of the vehicle 106. In other aspects, the system 108 may be hosted on a server, and the vehicle 106 may be communicatively coupled with the server.

The system 108 may be configured to recommend one or more charging stations to the vehicle user such that the vehicle user may quickly charge the vehicle 106 at the recommended charging station, and/or the vehicle user may feel comfortable charging the vehicle 106 at the recommended charging station (especially if the charging station is located in a secluded area). For example, the system 108 may identify a charging station for the vehicle user where the vehicle user may not be required to wait a considerable time duration to charge the vehicle 106, thereby enabling the vehicle user to quickly charge the vehicle 106 and exit the charging station. This may enhance user's convenience of charging the vehicle 106 at the charging station, especially if the charging station is located in a secluded area (or may not have proper lighting or guards, etc.).

The system 108 may identify an optimal charging station for the vehicle user based on a plurality of parameters/criteria described below. The example parameters described below should not be construed as limiting, and the system 108 may identify the optimal charging station based on additional parameters as well, without departing from the present disclosure scope.

In a first exemplary aspect, the system 108 may identify and recommend a charging station (e.g., a first recommended charging station), from the charging stations 104, which may require the vehicle 106 to spend the lowest or least amount of time to charge the vehicle 106 at the recommended charging station. Stated another way, the first recommended charging station may be that charging station, from the charging stations 104, which may be associated with the shortest or lowest vehicle charging time. In this case, the system 108 may obtain real-time waiting times at each charging station 104 and/or information indicating presence or absence of fast chargers at each charging station 104. In an exemplary aspect, the fast chargers may be those chargers that may be capable of suppling 240 Volt power. In some aspects, the information indicating the presence or absence of fast chargers may also indicate presence or absence of high power rated chargers (e.g., chargers capable of charging at 50 kW, 150 kW, 350 kW, etc.). Responsive to obtaining the information described above, the system 108 may determine a real-time expected vehicle charging time at each charging station 104 based on the real-time waiting times and/or the information indicating presence or absence of fast chargers at each charging station 104. Responsive to determining the real-time expected vehicle charging time associated with each charging station 104, the system 108 may identify and recommend a charging station (e.g., the charging station 104a or the first recommended charging station) to the vehicle user that may have the lowest or shortest expected vehicle charging time.

In some aspects, the system 108 may further identify and recommend a charging station (e.g., the first recommended charging station) based on a vehicle travel time required by the vehicle 106 to travel from a current vehicle geolocation to the first recommended charging station's location, in addition to identifying and recommending the charging station based on the vehicle charging time. Specifically, in some aspects, the system 108 may recommend the first recommended charging station (i.e., the charging station associated with the lowest/shortest vehicle charging time) to the vehicle user when the vehicle travel time to the first recommended charging station may also be the lowest (from amongst the vehicle travel times associated with the charging stations 104). In other aspects, the system 108 may recommend the first recommended charging station to the vehicle user when the vehicle travel time to the first recommended charging station may be marginally higher (e.g., less than 20% higher) than the vehicle travel times associated with the other charging stations 104; however, the vehicle charging time at the first recommended charging station may be considerably lower (e.g., more than 40% lower) than the charging times at the other charging stations 104.

In further aspects, the system 108 may identify and recommend a charging station based on user preferences and/or vehicle capabilities. For example, if the vehicle 106 is equipped with wireless charging capabilities, the system 108 may identify and recommend a charging station (from the charging stations 104) to the vehicle user that may have wireless chargers. A person ordinarily skilled in the art may appreciate that the vehicle user may feel comfortable charging at a charging station that provides wireless charging facility, since the vehicle user may not be required to exit the vehicle 106 to charge the vehicle 106 at such a charging station. The vehicle user may prefer charging at such charging stations (as opposed to other conventional charging stations where the vehicle user may be required to exit the vehicle 106 to plug/unplug the charging cord), especially if the charging station is located in a secluded area.

As another example, the system 108 may identify and recommend a charging station (from the charging stations 104) to the vehicle user based on acceptability ratings or scores (that may range from 1 to 5, with a rating of 5 being the best) associated with each charging station 104 and a user desired or preferred acceptability rating. In some aspects, the system 108 may identify and recommend a charging station that may have an associated acceptability rating greater than the user desired acceptability rating. For example, if the user desired acceptability rating is 4, the system 108 may identify and recommend a charging station that may have an associated acceptability rating of more than 4. In an exemplary aspect, an acceptability rating for a charging station may be associated with at least one of a presence of cameras at the charging station, a presence of authorities, a presence of an escort to and from the charging station, historical adverse event rate at the charging station, a presence of one or more places of interest (e.g., restaurants, cafes, etc.) in proximity to the charging station, a presence of a waiting facility with an attendant at the charging station, and/or the like.

Responsive to identifying a recommended charging station based on one or more parameters/criteria described above, the system 108 may transmit information associated with the recommended charging station (or “recommended charging station information”) to the vehicle 106 and/or a user device associated with the vehicle user. The recommended charging station information may include, e.g., a recommended charging station geolocation, its acceptability rating, an expected vehicle charging time at the charging station, an indication of presence or absence of fast chargers, wireless chargers, etc. at the charging station, and/or the like.

The vehicle user may drive the vehicle 106 to the recommended charging station (e.g., the first recommended charging station) or the vehicle 106 may itself travel to the first recommended charging station if the vehicle 106 is an autonomous vehicle, responsive to the vehicle 106 and/or the user device receiving the recommended charging station information. In some aspects, in addition to identifying the first recommended charging station (as described above), the system 108 may be additionally configured to enhance user's experience of charging the vehicle 106, when the vehicle 106 reaches the first recommended charging station, as described below.

In a scenario when the vehicle 106 reaches the first recommended charging station and the vehicle user finds the first recommended charging station not to the vehicle user's liking (e.g., if the first recommended charging station is not lighted, has non-working cameras, etc.), the vehicle user may transmit (via a vehicle Human-Machine Interface (HMI) and/or the user device) a request to the system 108 to identify and recommend another charging station (e.g., a second recommended charging station) from where the vehicle user may charge the vehicle 106. Responsive to receiving the request, the system 108 may identify the second recommended charging station (from the charging stations 104), such that the second recommended charging station may be closest to the vehicle's current location (i.e., the first recommended charging station location) and/or be the closest charging station with the acceptability rating greater than the user desired acceptability rating, vehicle charging time less than a predefined threshold, and/or the like.

The system 108 may further determine a minimum vehicle charge that may be required by the vehicle 106 to travel from the first recommended charging station to the second recommended charging station, and output a second recommendation charging station location and a notification to the vehicle user (via the vehicle HMI and/or the user device) indicating the minimum vehicle charge that may be required for the vehicle travel from the first recommended charging station location to the second recommended charging station location. Responsive to viewing/hearing the notification, the vehicle user may quickly charge the vehicle 106 to the minimum vehicle charge level (if the State of Charge (SoC) of the vehicle battery is low) at the first recommended charging station, and then travel to the second recommended charging station. In this manner, the system 108 may facilitate the vehicle user to identify and travel to another charging station (e.g., the second recommended charging station), if the vehicle user finds the first recommended charging station in an unacceptable condition (or in a condition not to the vehicle user's liking).

In additional aspects, the system 108 may enable the vehicle 106 to adjust or adapt a charge time at the first recommended charging station and/or an amount of charge to be transferred to the vehicle 106 based on real-time charging station information associated with the first recommended charging station. In some aspects, the real-time charging station information may include information associated with a count of users or vehicles located at the first recommended charging station, a presence of authorities, a presence of infrastructure lighting, cameras, and/or the like. As an example, the system 108 may cause the vehicle 106 (e.g., by transmitting a command signal) to charge for a short charge time (e.g., less than a predefined charge time threshold) or charge only till the vehicle SoC level reaches to 30%, if the real-time charging station information indicates that the count of users or vehicles located at the first recommended charging station may be less than a predefined count (e.g., two or three) and/or the first recommended charging station does not have presence of authorities (e.g., guards).

In additional aspects, the system 108 may cause the vehicle 106 to illuminate one or more vehicle exterior lights (e.g., vehicle perimeter lights), and/or to activate vehicle's exterior cameras and start recording, when the vehicle 106 may be located at the first recommended charging station (and may be getting charged). A person ordinarily skilled in the art may appreciate that the vehicle user may feel comfortable at the charging station knowing that the vehicle cameras are recording vehicle's surroundings and/or when the vehicle's periphery may be illuminated, especially when the first recommended charging station may be located in a secluded area.

The system 108 may further enable one or more additional vehicles located at the first recommended charging station (and adjacent to the vehicle 106) to illuminate their exterior lights (e.g., vehicle perimeter lights) to make the vehicle user feel comfortable at the charging station. The system 108 may additionally enable a plurality of vehicle users associated with a plurality of vehicles to form a group (similar to a social networking group of users), and facilitate the group to charge their respective vehicles together at a charging station. A person ordinarily skilled in the art may appreciate that vehicle users may feel more comfortable and assured at the charging station, when a large group of known people/users charge their vehicles together, especially if the charging station is located in a secluded area.

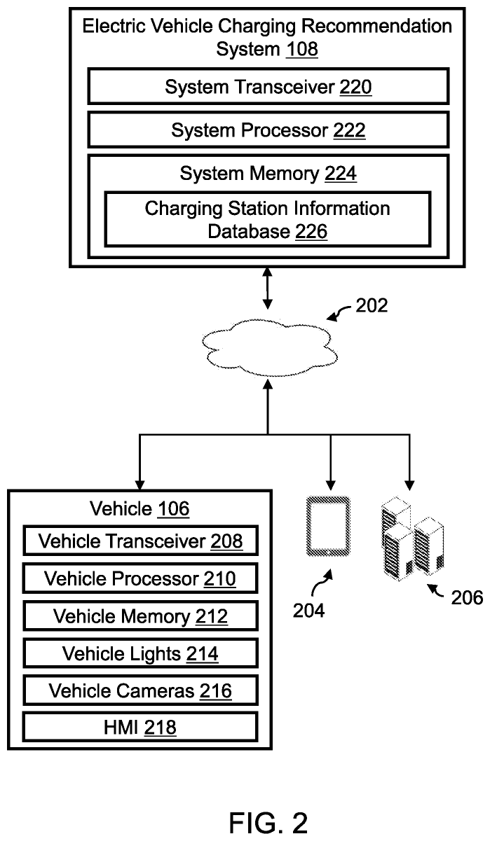

The system 108 may perform a plurality of additional actions to enable the vehicle user feel comfortable at the recommended charging station, when the vehicle user may be charging the vehicle 106 at the charging station. Details of such additional actions, and further system details are described below in conjunction with FIG. 2.

The vehicle 106 and the system 108 implement and/or perform operations, as described here in the present disclosure, in accordance with the owner manual and safety guidelines. In addition, any action taken by the user/occupant associated with the vehicle 106 based on the notifications/recommendations provided by the system 108 should comply with all the rules specific to the location and operation of the vehicle 106 (e.g., Federal, state, country, city, etc.). The notifications/recommendations, as provided by the system 108, should be treated as suggestions and only followed according to any rules specific to the location and operation of the vehicle 106.

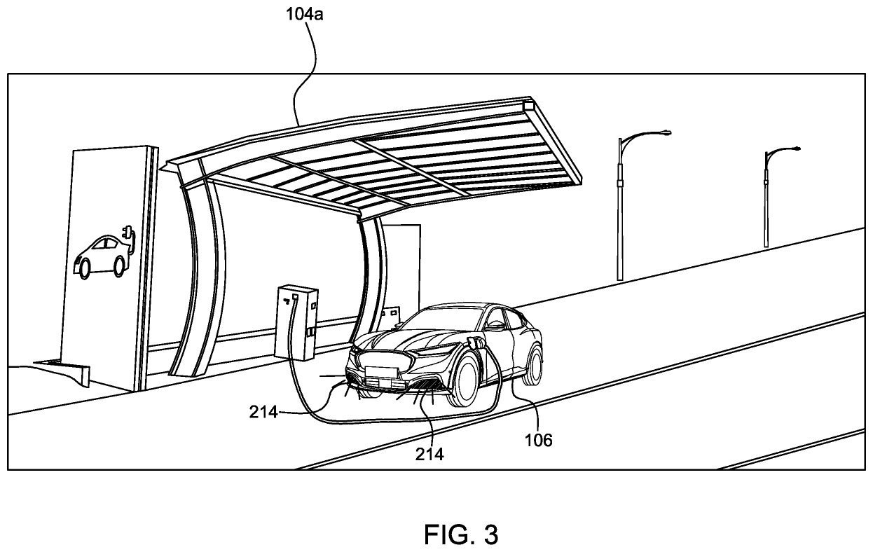

FIG. 2 depicts a block diagram of the electric vehicle charging recommendation system 108 in accordance with the present disclosure. While describing FIG. 2, references will be made to FIGS. 3-6. As described above, in some aspects, the system 108 may be part of the vehicle 106. In other aspects, the system 108 may be part of a server that may be communicatively coupled with the vehicle 106.

When the system 108 may be part of a server, the system 108 may be communicatively coupled with the vehicle 106 via one or more networks 202 (or a network 202). The system 108 may further be communicatively coupled with a user device 204 and one or more servers 206 (or a server 206), via the network 202. The user device 204 may be associated with the vehicle user/operator of the vehicle 106, and may be, for example, a mobile phone, a laptop, a computer, a tablet, a wearable device, or any other device with communication capabilities.

The server 206 may be part of a cloud-based computing infrastructure and may be associated with and/or include a Telematics Service Delivery Network (SDN) that provides digital data services to the vehicle 106 and/or the system 108. In further aspects, the server 206 may be configured to store charging station information associated with the charging stations 104. The charging station information may include, but is not limited to, information associated with real-time waiting times and presence of fast chargers at the charging stations 104, information associated with presence of wireless chargers at the charging stations 104, acceptability ratings associated with the charging stations 104, information associated with historical adverse events at the charging stations 104, a charging station geolocation associated with each charging station 104, and/or the like. The server 206 may transmit the charging station information described above to the system 108 at a predefined frequency, or when the system 108 transmits a request to the server 206 to obtain the charging station information.

The network 202 illustrates an example communication infrastructure in which the connected devices discussed in various embodiments of this disclosure may communicate. The network 202 may be and/or include the Internet, a private network, public network or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 106 may include a plurality of units including, but not limited to, a vehicle transceiver 208, a vehicle processor 210, a vehicle memory 212, one or more vehicle lights 214, one or more vehicle cameras 216, and a vehicle Human-Machine Interface (HMI) 218. The vehicle transceiver 208 may be configured to transmit/receive information/data to/from external systems and devices via the network 202. For example, the vehicle transceiver 208 may be configured to receive/transmit inputs/information/data from/to the system 108, the user device 204, the server 206, and/or the like.

The vehicle processor 210 may be disposed in communication with one or more memory devices disposed in communication with the respective computing systems (e.g., the vehicle memory 212 and/or one or more external databases not shown in FIG. 2). The vehicle processor 210 may utilize the vehicle memory 212 to store programs in code and/or to store data for performing aspects in accordance with the disclosure. The vehicle memory 212 may be a non-transitory computer-readable storage medium or memory storing a program code that enables the vehicle processor 210 to perform operations in accordance with the present disclosure. The vehicle memory 212 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The vehicle lights 214 may be, for example, one or more vehicle interior or exterior lights, vehicle perimeter lights, etc. The vehicle cameras 216 may be, for example, one or more vehicle interior or exterior cameras configured to capture images/videos of vehicle's surroundings and/or vehicle's interior portion. The HMI 218 may include a touch screen interface configured to receive vehicle user's inputs, and/or output/display notifications, navigation maps, and/or the like.

The system 108 may include a plurality of units including, but not limited to, a system transceiver 220, a system processor 222 and a system memory 224. The system transceiver 220 may be configured to transmit/receive information/data to/from external systems and devices via the network 202. For example, the system transceiver 220 may be configured to receive/transmit inputs/information/data from/to the vehicle 106, the user device 204, the server 206, and/or the like.

The system processor 222 and the system memory 224 may be similar to the vehicle processor 210 and the vehicle memory 212, respectively. Specifically, the system processor 222 may be disposed in communication with one or more memory devices disposed in communication with the respective computing systems (e.g., the system memory 224 and/or one or more external databases not shown in FIG. 2). The system processor 222 may utilize the system memory 224 to store programs in code and/or to store data for performing aspects in accordance with the disclosure. The system memory 224 may be a non-transitory computer-readable storage medium or memory storing a program code that enables the system processor 222 to perform operations in accordance with the present disclosure. The system memory 224 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the system memory 224 may include a charging station information database 226 that may store the charging station information, which the system 108 may receive from the server 206. The system memory 224 may further include one or more additional databases (not shown) that may store inputs/data/information that the system 108 may receive from the user device 204 and/or the vehicle 106.

In operation, the vehicle user may transmit, via the HMI 218 and/or the user device 204, a request to the system 108 to recommend one or more charging stations in the geographical area 102 at which the vehicle user may charge the vehicle 106. The system transceiver 220 may receive the request from the HMI 218 and/or the user device 204, via the network 202. The system transceiver 220 may further receive the charging station information associated with the charging stations 104 from the server 206, via the network 202. The examples of the charging station information are already described above. The system transceiver 220 may transmit the request and the charging station information to the system memory 224 for storage purpose, and/or to the system processor 222.

The system processor 222 may obtain the request and the charging station information from the system memory 224 or directly from the system transceiver 220. In some aspects, the system processor 222 may obtain a “trigger signal” when the system processor 222 obtains the request from the system memory 224 or the system transceiver 220. Responsive to obtaining the trigger signal, the system processor 222 may estimate a vehicle charging time associated with each charging station 104 based on the charging station information. In some aspects, the system processor 222 may estimate the vehicle charging time associated with each charging station 104 based on the information associated with real-time waiting times and presence of fast chargers at the charging stations 104, which may be part of the charging station information obtained by the system processor 222.

Responsive to estimating the vehicle charging time, the system processor 222 may determine a first recommended charging station, from the charging stations 104, at which the vehicle user may charge the vehicle 106. In a first exemplary aspect, the system processor 222 may determine the first recommended charging station based on the estimated vehicle charging time associated with each charging station 104, such that the first recommended charging station is associated with a lowest or shortest vehicle charging time. Responsive to determining the first recommended charging station, the system processor 222 may transmit/output, via the system transceiver 220, information associated with the first recommended charging station (or “first recommended charging station information”) to the vehicle 106/HMI 218 and/or the user device 204. In some aspects, the first recommended charging station information may include a first recommended charging station geolocation, and/or navigation instructions to travel to the first recommended charging station location. The vehicle user may view/hear the first recommended charging station information, and drive the vehicle 106 to the first recommended charging station to charge the vehicle 106. If the vehicle 106 is an autonomous vehicle, the vehicle 106 may autonomously move towards the first recommended charging station, responsive to receiving the first recommended charging station information. In this manner, the system 108 may facilitate the vehicle user to charge the vehicle 106 at a charging station that may have lowest or shortest vehicle charging time, so that the vehicle user may quickly exit the first recommended charging station after charging the vehicle 106. This may enhance vehicle user's convenience of charging the vehicle 106, especially if the first recommended charging station is located in a secluded area.

In a second exemplary aspect, in addition to or alternative to determining the first recommended charging station based on the estimated vehicle charging time, the system processor 222 may determine the first recommended charging station based on vehicle travel times required by the vehicle 106 to travel from a current vehicle location to the charging stations 104. In this case, the system transceiver 220 may receive a real-time vehicle geolocation associated with the vehicle 106 from the vehicle 106, and the system transceiver 220 may transmit the real-time vehicle geolocation to the system processor 222. Responsive to obtaining the real-time vehicle geolocation from the system transceiver 220, the system processor 222 may determine a vehicle travel time from the real-time vehicle geolocation to each charging station 104. The system processor 222 may then determine the first recommended charging station based on the vehicle travel time.

In some aspects, the system processor 222 may determine the first recommended charging station (i.e., the charging station associated with the lowest/shortest vehicle charging time) when the vehicle travel time to the first recommended charging station may also be the lowest (from amongst the vehicle travel times associated with the charging stations 104). In other aspects, the system 108 may determine the first recommended charging station when the vehicle travel time to the first recommended charging station may be marginally higher (e.g., less than 20% higher) than the vehicle travel times associated with the other charging stations 104; however, the vehicle charging time at the first recommended charging station may be considerably lower (e.g., more than 40% lower) than the charging times at the other charging stations 104. In some aspects, the vehicle charging time and vehicle travel time tradeoff threshold/factor (e.g., only accept the faster charger if it reduces charging time by some multiple of additional vehicle travel time) may be calibrated/provided by the vehicle user to the system 108. This tradeoff may be adaptive based on charging station location as well (e.g., if charging at an unknown area, the tradeoff threshold may be lower). Further, if a small charge time benefit is realized (e.g., 1 minute) at a charging station, but the vehicle user has to travel 10 minutes out of the way, the system processor 222 may not recommend such a charging station to the vehicle user.

In further aspects, the system processor 222 may determine the first recommended charging station, from the charging stations 104, based on the information associated with the presence of wireless chargers at the charging stations 104 (that may be part of the charging station information). In this case, the system processor 222 may first determine whether the vehicle 106 is capable of wireless charging, based on inputs obtained from the vehicle 106. Responsive to determining that the vehicle 106 may be capable of wireless charging, the system processor 222 may determine the first recommended charging station such that the charging station may include wireless charging capability or wireless chargers. A person ordinarily skilled in the art may appreciate that in such charging stations, the vehicle user may simply drive-up, pay electronically, charge the vehicle 106 and drive away from the charging station, without having to leave/exit the vehicle 106. This may significantly enhance user's convenience, especially if the first recommended charging station is located in a secluded area. Furthermore, if the vehicle user feels uncomfortable or threatened at the first recommended charging station when the vehicle 106 may be getting charged, the vehicle user may simply drive away, without having to unplug any charging cord, thereby further enhancing user comfort and charging experience.

In yet another aspect, the system processor 222 may determine the first recommended charging station, from the charging stations 104, based on the acceptability ratings associated with the charging stations 104 (that may be part of the charging station information). Specifically, the system processor 222 may determine the first recommended charging station such that the first recommended charging station may have an associated acceptability rating greater than a user preferred or user desired acceptability rating (that the system 108 may obtain from the HMI 218 and/or the user device 204), as described above in conjunction with FIG. 1. In some aspects, an acceptability rating for a charging station may be associated with one or more of a presence of cameras, a presence of authorities, a presence of an escort to and from the charging station, historical adverse event rate at the charging station, a presence of one or more places of interest (e.g., restaurants, cafes, etc.) in proximity to the charging station, a presence of a waiting facility with an attendant at the charging station, and/or the like.

As described above, responsive to determining the first recommended charging station based on one or more parameters/criteria described above, the system processor 222 may transmit/output, via the system transceiver 220, the first recommended charging station information/geolocation to the vehicle 106 and/or the user device 204. Responsive to receiving the first recommended charging station geolocation, the vehicle user may drive the vehicle 106 to the first recommended charging station (e.g., the charging station 104a). In some aspects, in addition to determining an optimal charging station (e.g., the charging station 104a) for the vehicle user, the system processor 222 may perform one or more additional actions to enhance user's experience of charging the vehicle 106, when the vehicle 106 may reach the charging station 104a or when the vehicle 106 may be getting charged at the charging station 104a (or any other charging station), as described below.

In some aspects, if the vehicle user determines that the charging station 104a may not be to the vehicle user's liking (e.g., the charging station 104a may be in a suboptimal condition) when the vehicle 106 reaches the charging station 104a, the vehicle user may transmit, via the HMI 218 and/or the user device 204, a request to the system 108 to identify one or more additional/other recommended charging stations in the geographical area 102. The system processor 222 may obtain the request from the HMI 218 and/or the user device 204 (via the system transceiver 220), and may determine a second recommended charging station (e.g., the charging station 104b) responsive to obtaining the request. In some aspects, the system processor 222 may determine the charging station 104b based on the vehicle charging time associated with each charging station 104 and/or distances between the real-time vehicle geolocation/the charging station 104a and the remaining charging stations 104. In an exemplary aspect, the system processor 222 may determine the charging station 104b such that the charging station 104b may be closest to the charging station 104a, and/or be the closest charging station to the charging station 104b with the acceptability rating greater than the user desired acceptability rating, the vehicle charging time less than a predefined threshold, and/or the like.

In further aspects, the system processor 222 may determine a minimum vehicle charge required by the vehicle 106 to travel from the charging station 104a to the charging station 104b, based on the distance between the first and second charging stations 104a, 104b (and other parameters including vehicle operational characteristics, real-time traffic between the first and second charging stations 104a, 104b, and/or the like). Responsive to determining the minimum vehicle charge, the system processor 222 may transmit/output, information associated with the minimum vehicle charge and the geolocation associated with the charging station 104b to the vehicle 106 and/or the user device 204. If the vehicle SoC may be low, the vehicle user may charge the vehicle 106 up to the minimum vehicle charge level, quickly exit the charging station 104a, and then travel to the charging station 104b. In this manner, the system 108 may facilitate the vehicle user to quickly exit a charging station not liked by the vehicle user, and travel to another (and better) charging station.

In additional aspects, the system processor 222 may enable the vehicle 106 to adjust or adapt a vehicle charging strategy, a charge time at the charging station 104a and/or an amount of charge to be transferred to the vehicle 106 at the charging station 104a based on real-time charging station information associated with the charging station 104a, when the vehicle 106 reaches the charging station 104a. The system processor 222 may obtain the real-time charging station information from one or more infrastructure sensors installed at the charging station 104a, one or more vehicle sensors (e.g., the vehicle cameras 216), one or more computing systems associated with the charging station 104a, and/or the like. The real-time charging station information may include, for example, information associated with a count of users or vehicles located at the charging station 104a, a presence of authorities, a presence of infrastructure lighting, cameras, historical adverse events, and/or the like.

In an exemplary aspect, to enable the vehicle 106 to adjust or adapt the vehicle charging strategy, the charge time and/or the amount of charge, the system processor 222 may first determine that the vehicle 106 has reached the charging station 104a (e.g., via the real-time vehicle geolocation). Responsive to determining that the vehicle 106 has reached the charging station 104a, the system processor 222 may obtain the real-time charging station information. The system processor 222 may then determine an optimal charging parameter associated with the vehicle 106 based on the real-time charging station information. In some aspects, the optimal charging parameter may be associated with a recommended vehicle charge time at the charging station 104a, and/or a recommended amount of charge to be transferred to the vehicle 106 at the charging station 104a. Responsive to determining the optimal charging parameter, the system processor 222 may transmit, via the system transceiver 220, the optimal charging parameter to the vehicle 106, to cause the vehicle 106 to charge at the charging station 104a based on the determined optimal charging parameter.

In some aspects, the system processor 222 may determine the optimal charging parameter such that the vehicle 106 may not have to spend a considerable time duration at a charging station (e.g., the charging station 104a) to charge the vehicle 106, while at the same time minimizing a count of charging stops the vehicle 106 may have to take on a vehicle trip. The system processor 222 may further determine the optimal charging parameter such that the vehicle 106 has enough charge to travel to the vehicle's home location (if the vehicle's home location is within a predefined distance threshold from the charging station 104a). In further aspects, the system processor 222 may learn/determine the recommended vehicle charge time and/or the recommended amount of charge to be transferred to the vehicle 106 based on historical charging events associated with the vehicle 106 and/or the historical adverse events associated with the charging station 104a. A person ordinarily skilled in the art may appreciate that a probability of any adverse event reduces considerably if the vehicle 106 spends less time at the charging station 104a (e.g., if the charging station 104a is located at a secluded area).

In additional aspects, to further enhance user convenience, the system processor 222 may transmit (via the system transceiver 220) a command signal to the vehicle 106 to cause the vehicle 106 to perform a predefined action, when the system processor 222 determines that the vehicle 106 may have reached the charging station 104a. In an exemplary aspect, the predefined action may include activating the vehicle lights 214 (or vehicle perimeter lights), as shown in FIG. 3. A person ordinarily skilled in the art may appreciate that the vehicle user may feel comfortable at the charging station 104a when the area in proximity to the vehicle 106 may be illuminated. Therefore, the system processor 222 may cause the vehicle 106 to illuminate the vehicle lights 214 to enhance user's convenience of charging the vehicle 106 at the charging station 104a.

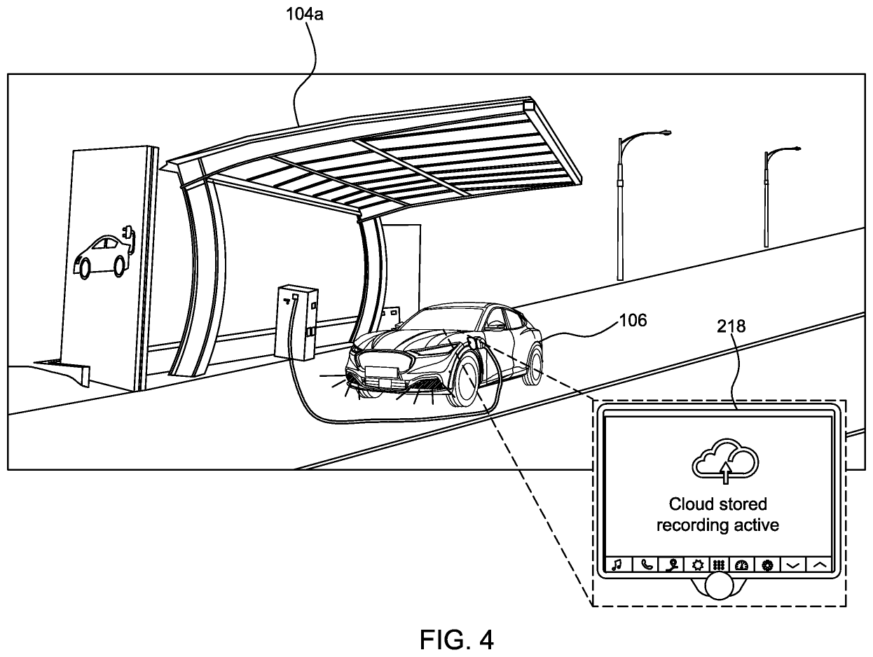

In another exemplary aspect, the predefined action may include activating the vehicle cameras 216 (e.g., external vehicle cameras) to record vehicle's surroundings, and outputting an alert notification to the HMI 218 indicating that the vehicle cameras 216 may be recording the vehicle's surroundings and storing the recording in the system memory 224 and/or the cloud, as shown in FIG. 4. The vehicle 106 may activate the vehicle cameras 216 regardless of whether the vehicle user may be in the vehicle 106, or outside the vehicle 106 (e.g., to plug/unplug the charging cord, or to visit a nearby restaurant). The HMI 218 may further display the recording, to make passersby aware that the vehicle cameras 216 may be recording the vehicle's surroundings. The vehicle 106 may further leverage exterior vehicle displays, head-up displays (HUDs), laser headlights, projectors from the vehicle 106, side view mirrors, and/or the like, to make passersby aware that the camera recordings may be taking place (without having to make the passersby approach near to the vehicle 106). In some aspects, the displays described above may be activated when a passerby may be located within a predefined distance (e.g., 10-15 feet) of the vehicle 106. A person ordinarily skilled in the art may appreciate that the vehicle user may feel comfortable at the charging station 104a when the vehicle's surrounding may be getting recorded (and the recordings may be getting stored in the system memory 224/cloud).

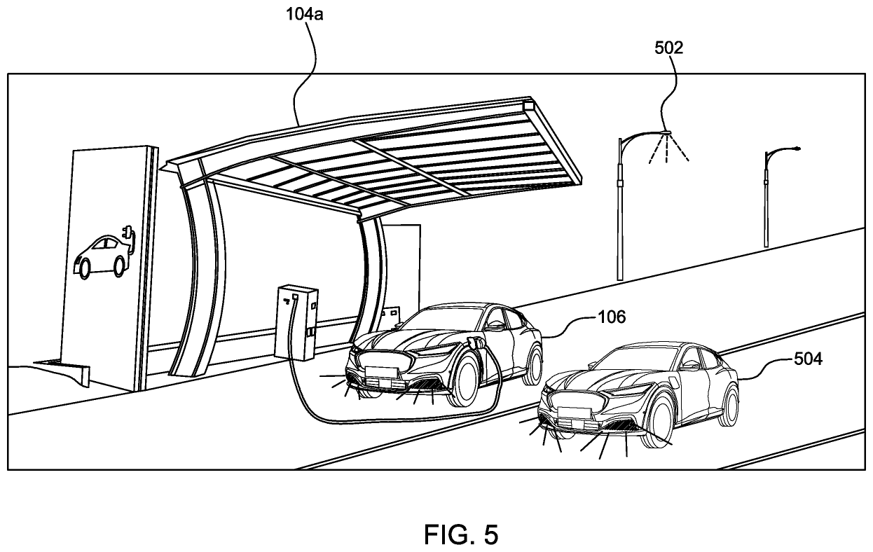

In yet another exemplary aspect, the predefined action may include transmitting, by the vehicle transceiver 208 via vehicle-to-vehicle (V2V) communication and/or vehicle-to-infrastructure (V2I) communication, a light activation request to one or more additional vehicles or infrastructure lights in proximity to the vehicle 106 at the charging station 104a. Responsive to receiving the light activation request, the infrastructure lights may illuminate, and the additional vehicles may cause their respective perimeter or external lights to illuminate if the vehicles have enough SoC (and determine that the light activation request is a legitimate urgent request), as shown in FIG. 5. FIG. 5 depicts an example view of an infrastructure light 502 in the charging station 104a in an illuminated state, and a vehicle 504 at the charging station 104a with perimeter lights activated. Illumination of the infrastructure light 502 and the lights associated with the vehicle 504 may make the vehicle user feel more comfortable, when the vehicle 106 may be located at the charging station 104a.

The system 108 may perform one or more additional actions to further enhance the vehicle user's charging experience at the charging station 104a. For example, the system processor 222 may determine a group of vehicles (including the vehicle 106), travelling on a route including the charging station 104a, in which each vehicle may require vehicle charging. In some aspects, the system processor 222 may determine the group of vehicles based on a remaining range in each vehicle, a travel time duration since last stop for each vehicle, vehicle user preferences to drive without stopping (e.g., 2 hour drive and then stop, or 4 hour drive and then stop), an expected vehicle charge time for each vehicle, vehicle cruise speeds on highways, vehicle user hobbies or interests for specific types of restaurants, cafes, and/or the like.

Responsive to determining the group of vehicles, the system processor 222 may transmit, via the system transceiver 220, a charge notification to the group of vehicles. The charge notification may include a geolocation associated with the charging station 104a and a recommended time to reach the charging station 104a, so that all the vehicles stop at the same time to charge at the charging station 104a or have charge periods overlap to deter isolated individual vehicle charging (especially during night time). A person ordinarily skilled in the art may appreciate that the vehicle user may feel comfortable charging the vehicle 106 at the charging station 104a if a group of vehicles/users collectively visit the charging station 104a to charge respective vehicles.

In some aspects, the system processor 222 may perform background checks or verification of vehicle users associated with the group of vehicles, before determining or “forming” the vehicle group to visit the charging station 104a together. Further, the system processor 222 may section off different vehicle groups to different parts of the charging station 104a so it can turn into a networking type event (e.g., “social charging”). Furthermore, the system processor 222 may plan the charging based on route guidance (e.g., a predefined miles ahead of time), and charging stops may be planned based on estimated remaining range of specific vehicles in the vehicle group (e.g., the vehicles having minimum SoC/range left). The system processor 222 may also coordinate vehicle departure times for long trips.

In further aspects, the system processor 222 may ensure that the vehicle group includes at least two vehicles and does not include more than a threshold count of vehicles (e.g., five or six vehicles), to better coordinate and plan the charging event(s). In additional aspects, the system processor 222 may enable V2V communication between the vehicles in the group, to perform a similarity weighting between travelers in the same group and to find the best match for vehicle grouping.

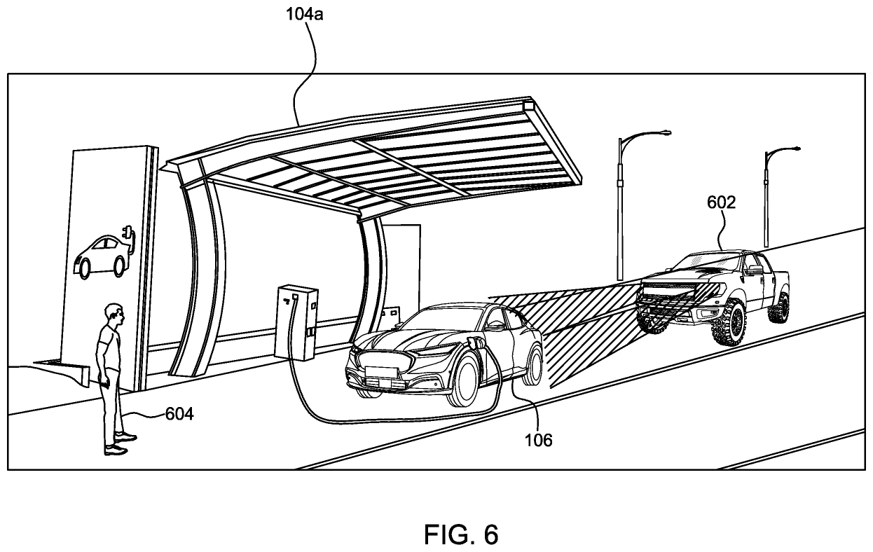

In additional aspects, the system processor 222 may transmit (via the system transceiver 220) a request to another vehicle (e.g., a vehicle 602, shown in FIG. 6) or a user device associated with an authorized user (e.g., a user 604, shown in FIG. 6) to monitor the vehicle 106 at the charging station 104a, when the system processor 222 determines that the vehicle 106 may have reached the charging station 104a. In some aspects, the vehicle 602 and/or the user 604 may be associated with a paid security service (e.g., paid police), which may monitor and/or circle the vehicle 106 at the charging station 104a, responsive to receiving the request from the system processor 222. A person ordinarily skilled in the art may appreciate that the vehicle user may feel comfortable at the charging station 104a when the vehicle 602 and/or the user 604 may be monitoring the vehicle 106.

In other aspects, the vehicle 602 and/or the user 604 may be located in a neighborhood of the charging station 104a, and may monitor the vehicle 106 at the charging station 104a in exchange for free or discounted charging at the charging station 104a (including a fee for possible route modifications to make a loop through the charging station 104a location). In further aspects, the vehicle 602 may be associated with a firm that provides vehicles for monitoring customer vehicles (e.g., the vehicle 106) at the charging station 104a, when the firm receives the request from the system 108/system processor 222. In this case, as part of the monitoring, the vehicle 602 may point its headlights on the vehicle 106, as shown in FIG. 6. Such monitoring action may illuminate the area where the vehicle 106 may be located at the charging station 104a, thereby making the vehicle user feel more comfortable.

In some aspects, the vehicle 602 may initiate the monitoring of the vehicle 106 by recognizing a picture, model, BLE signature, passcode, etc. associated with the vehicle 106 (that may be provided to the vehicle 602) and a vehicle user picture, when the vehicle 106 reaches the charging station 104a. Further, the vehicle 602 may record a video of the vehicle 106 at the charging station 104a by using the cameras associated with the vehicle 602, and transmit the recorded video to the cloud for storage.

In further aspects, the user 604 may be a certified or an authorized user registered with the system 108 (e.g., a Good Samaritan), who may have volunteered to monitor customer vehicles at the charging station 104a. As an example, the user 604 may be getting the user's vehicle charged at the charging station 104a, when the vehicle 106 reaches the charging station 104a. In this case, the user 604 may wait till the vehicle 106 is charged and monitor the vehicle 106, before leaving the charging station 104a. In some aspects, the vehicle user may also broadcast a request (e.g., via the vehicle 106 and/or the user device 204) to get monitored, and the user 604 may monitor the vehicle 106 responsive to viewing/hearing the broadcasted request.

In some aspects, the system 108 and/or the vehicle user may compensate the user 604 (via a preset fees, predefined services, or discounted charging at the charging station 104a), in exchange for the vehicle monitoring.

In additional aspects, the system 108 may enable a plurality of users to rent-out their home chargers for the vehicle user to charge the vehicle 106. In this case, the system 108 may perform background checks/verifications of the plurality of users, before recommending the vehicle user to charge the vehicle 106 at one of the home chargers.

Although the description above describes an aspect where the system 108 recommends an optimal charging station to the vehicle operator to charge the vehicle 106, the present disclosure is not limited to such an aspect. In additional aspects, the vehicle operator may transmit the request to the system 108 to identify an optimal charging station where the vehicle operator may charge a trailer, a portable EV power pack, a vehicle under tow, and/or the like (and not necessarily the vehicle 106). In this case, the system 108 may identify a charging station for the vehicle operator in substantially the same manner as described above; however, in this case, the system 108 may identify charging stations with wireless chargers only when the trailer, the portable EV power pack, the vehicle under tow, etc. may have wireless charging capabilities. Further, in this case, the system 108 may not be required to determine a minimum vehicle charge required by the vehicle 106 to travel from the charging station 104a to the charging station 104b based on the distance between the first and second charging stations 104a, 104b, as the vehicle 106 may not require charging at the charging stations 104a/104b. In this case, as an example, the system 108 may identify the charging station 104b based on the acceptability ratings, the user inputs, and/or the like.

Furthermore, in this aspect, the system 108 may execute the same/similar operations as described above (e.g., activating the vehicle lights 214, vehicle cameras, etc.) to make the vehicle operator feel comfortable at the charging station when the vehicle operator may be charging the trailer, the portable EV power pack, the vehicle under tow, and/or the like.

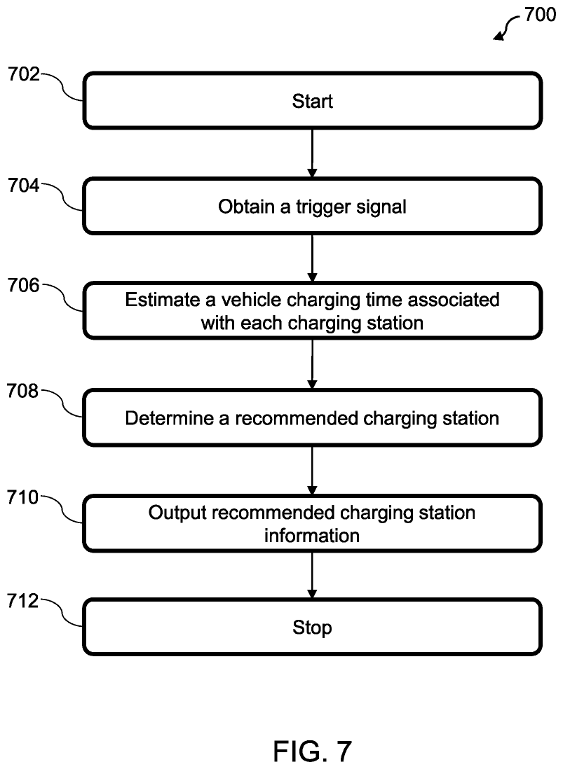

FIG. 7 depicts a flow diagram of an example electric vehicle charging recommendation method 700 in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the system processor 222, the trigger signal. At step 706, the method 700 may include estimating, by the system processor 222, the vehicle charging time associated with each charging station 104 based on the charging station information, responsive to obtaining the trigger signal.

At step 708, the method 700 may include determining, by the system processor 222, the first recommended charging station (e.g., the charging station 104a) based on the vehicle charging time. At step 710, the method 700 may include outputting, by the system processor 222, the information associated with the first recommended charging station, responsive to determining the first recommended charging station.

At step 712, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A recommendation system comprising:
a transceiver configured to receive charging station information, wherein the charging station information comprises information associated with real-time waiting times and presence of fast chargers at a plurality of charging stations located in a geographical area; and
a processor communicatively coupled with the transceiver, wherein the processor is configured to:
obtain a trigger signal;
estimate a vehicle charging time associated with each charging station based on the charging station information, responsive to obtaining the trigger signal;
determine a first recommended charging station, from the plurality of charging stations, based on the vehicle charging time; and
output a first recommended charging station information responsive to determining the first recommended charging station.

2. The recommendation system of claim 1, wherein the first recommended charging station is associated with a lowest vehicle charging time.

3. The recommendation system of claim 1, wherein the transceiver is further configured to receive a real-time vehicle geolocation associated with a vehicle, and wherein the processor is further configured to:
determine a vehicle travel time from the real-time vehicle geolocation to each charging station; and
determine the first recommended charging station based on the vehicle travel time.

4. The recommendation system of claim 1, wherein the processor obtains the trigger signal when the processor obtains a request from a user device or a vehicle to recommend one or more charging stations to charge the vehicle, and wherein the processor outputs the first recommended charging station information to the user device or the vehicle.

5. The recommendation system of claim 1, wherein the recommendation system is part of a vehicle.

6. The recommendation system of claim 1, wherein the first recommended charging station information comprises a first recommended charging station geolocation.

7. The recommendation system of claim 1, wherein the charging station information further comprises information associated with presence of wireless chargers at the plurality of charging stations, and wherein the processor is further configured to determine the first recommended charging station based on the information associated with the presence of wireless chargers.

8. The recommendation system of claim 1, wherein the charging station information further comprises acceptability ratings associated with the plurality of charging stations, wherein the processor is further configured to determine the first recommended charging station based on the acceptability ratings, and wherein the first recommended charging station has an associated acceptability rating greater than a desired acceptability rating.

9. The recommendation system of claim 8, wherein an acceptability rating for a charging station is associated with at least one of: a presence of cameras, a presence of authorities, a presence of an escort to and from the charging station, historical adverse event rate at the charging station, a presence of one or more places of interest in proximity to the charging station, or a presence of a waiting facility with an attendant at the charging station.

10. The recommendation system of claim 1, wherein the processor is further configured to:
obtain a request to identify one or more additional recommended charging stations when a vehicle reaches the first recommended charging station, responsive to outputting the first recommended charging station information;
determine a second recommended charging station responsive to obtaining the request;
determine a minimum vehicle charge required for a vehicle travel from the first recommended charging station to the second recommended charging station; and
output information associated with the minimum vehicle charge to the vehicle or a user device.

11. The recommendation system of claim 10, wherein the processor determines the second recommended charging station based on at least one of the vehicle charging time and distances between the first recommended charging station and the plurality of charging stations.

12. The recommendation system of claim 1, wherein the processor is further configured to:
determine that a vehicle has reached the first recommended charging station, responsive to outputting the first recommended charging station information;
obtain a real-time first charging station information when the vehicle reaches the first recommended charging station;
determine an optimal charging parameter associated with the vehicle based on the real-time first charging station information; and
cause the vehicle to charge at the first recommended charging station based on the optimal charging parameter.

13. The recommendation system of claim 12, wherein the real-time first charging station information comprises information associated with a count of users or vehicles located at the first recommended charging station and a presence of authorities at the first recommended charging station, and wherein the optimal charging parameter is associated with at least one of a recommended charge time at the first recommended charging station, and a recommended amount of charge to be transferred to the vehicle at the first recommended charging station.

14. The recommendation system of claim 1, wherein the processor is further configured to:
determine that a vehicle has reached the first recommended charging station, responsive to outputting the first recommended charging station information; and
cause the vehicle to perform a predefined action responsive to determining that the vehicle has reached the first recommended charging station.

15. The recommendation system of claim 14, wherein the predefined action comprises at least one of: activating a vehicle perimeter light, activating an exterior vehicle camera, outputting an alert notification, or transmitting a light activation request to one or more additional vehicles or infrastructure lights in proximity to the vehicle.

16. The recommendation system of claim 1, wherein the processor is further configured to:
determine a group of vehicles travelling on a route comprising the first recommended charging station, wherein each vehicle of the group of vehicles requires vehicle charging; and
transmit a charge notification to the group of vehicles, wherein the charge notification comprises a first recommended charging station geolocation and a recommended time to reach the first recommended charging station geolocation.

17. The recommendation system of claim 16, wherein the processor determines the group of vehicles based on at least one of a remaining range in each vehicle, a travel time duration since last stop for each vehicle, vehicle user preferences, or an expected vehicle charge time for each vehicle.

18. The recommendation system of claim 1, wherein the processor is further configured to:
determine that a first vehicle has reached the first recommended charging station, responsive to outputting the first recommended charging station information; and
transmit a request to a second vehicle or a user device associated with an authorized user to monitor the first vehicle at the first recommended charging station, responsive to determining that the first vehicle has reached the first recommended charging station.

19. A recommendation method comprising:
obtaining, by a processor, a trigger signal;
estimating, by the processor, a vehicle charging time associated with each charging station, from a plurality of charging stations located in a geographical area, based on charging station information associated with the plurality of charging stations responsive to obtaining the trigger signal, wherein the charging station information comprises information associated with real-time waiting times and presence of fast chargers at the plurality of charging stations;
determining, by the processor, a recommended charging station, from the plurality of charging stations, based on the vehicle charging time; and
outputting, by the processor, a recommended charging station information responsive to determining the recommended charging station.

20. A non-transitory computer-readable storage medium having instructions stored thereupon which, when executed by a processor, cause the processor to:
obtain a trigger signal;
estimate a vehicle charging time associated with each charging station, from a plurality of charging stations located in a geographical area, based on charging station information associated with the plurality of charging stations responsive to obtaining the trigger signal, wherein the charging station information comprises information associated with real-time waiting times and presence of fast chargers at the plurality of charging stations;
determine a recommended charging station, from the plurality of charging stations, based on the vehicle charging time; and
output a recommended charging station information responsive to determining the recommended charging station.
